(19) United States
(12) Patent Application Publication
(10) Pub. No.: US 2007/0110166 A1
(43) Pub. Date: May 17, 2007

(54) Method and device for determining the position of at least one point of reflection of an obstacle

(75) Inventor: Tadashi Amino, Tokyo (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 10/583,532

(22) PCT Filed: Nov. 5, 2004
(86) PCT No.: PCT/JP04/16429

§ 371 Date: Jun. 16, 2006

(30) Foreign Application Priority Data
Dec. 17, 2003 (JP) 2003-419063

(51) Int. Cl. H04N 11/02

(52) U.S. Cl. 375/240.25

(57) ABSTRACT

A signal generation device generates a packet containing information obtained by encoding a video signal by using a video signal of a predetermined number of vertical periods as a unit and adds serial number information indicating the generation order as a packet is generated. A signal decoding device includes a packet absence detection circuit for detecting the serial number information added to the packet received, thereby determining absence of the packet, and a memory for holding a video signal. When the packet lack detection circuit has not detected any packet absence, the memory is made to hold at least a part of the video signal decoded. When the packet lack detection circuit has detected a packet absence, the video signal held in the memory is output. The signal generation device and the signal decoding device constitute a simple circuit structure for suppressing image disorder caused by a transmission error.

### TECHNICAL FIELD

This invention relates to a radio video transmission device, a radio video reception device, a radio video transmission/reception system, a signal generation device, a signal correction device, and a signal generation/correction device, and is used for radio transmission of video from a main television device (a master television device) to a slave television device, for example.

### BACKGROUND ART

In digital broadcasting systems, video and voice signals are compressed by MPEG (Moving Picture Experts Group) compression encoding technique, for example, and a multiplexed transport stream (TS) is digitally modulated and transmitted as a digital modulation signal. On a receiver side, the received digital modulation signal is demodulated to generate a transport stream, which is divided and analyzed into video, voice, and other information. Thus, a video image such as a program is indicated on a display.

FIG. 5 shows a structure of a radio video transmission/reception system in a digital broadcasting system. Each of a video signal and a voice signal output from a DVD 30 and a VTR 32 is input to an NTSC encoder 11 and an audio analog-to-digital converter 36 where an analog signal is converted into a digital signal. The resultant digital signals are then input to a codec 38 where the digital signals are subjected to predetermined processing such as compression processing, and output as a transport stream. The transport stream is then modulated in a radio transmission section 40 and is output as a radio signal.

Meanwhile, the transmitted radio signal is received by a radio reception section 42 of a radio video reception device. The received radio signal is input to a codec 44 where the input radio signal is subjected to expansion (decompression) processing, which is an inverse process of that applied by the codec 38, to thereby obtain a video signal and a voice signal. The video signal and the voice signal are further input to an NTSC decoder 46 and an audio digital-to-analog converter 48, respectively. The NTSC decoder 46 and the audio digital-to-analog converter 48 apply digital-to-analog conversion to the video signal and the voice signal to generate respective analog signals, which are then output to a display 50. In this manner, a video signal which is radio-transmitted can be displayed on the display 50.

In the digital broadcasting system as described above, in order to reduce a transmission error of video data, a process which corrects the transmission error is performed, for example, by adding an error correction code to the video information. Error correction codes are classified into several kinds, depending on, for example, the volume of information that can be detected and corrected, and well-known examples of error correction codes include a parity code and a CRC code (HYPERLINK “http://e-words.jp/w/CRC.html”) (see Japanese Patent Laid-Open Publication No. 2002-64759, for example).

Recently, there has been proposed a reception system including a main body reception device (a main television device) which receives digital broadcast, and a slave television device which receives and displays video and voice data which are radio-transmitted from the main body reception device. In such a reception system, as in the digital broadcasting system described above, correction of a transmission error by addition of a parity bit or the like is considered.

However, the conventional error correction process described above requires circuits for generating an error correction code, adding the error correction code to a transmission signal, separating the error correction code from a reception signal, analyzing the error correction code, correcting information on the basis of the analysis result, and other processing, whereby the structure of a device becomes complicated.

In view of the above circumstances, the present invention advantageously provides a radio video transmission device, a radio video reception device, a radio video transmission/reception system, a signal generation device, a signal correction device, and a signal generation/correction device, which are capable of suppressing image disturbance caused by a transmission error with a simple circuit structure.

### DISCLOSURE OF THE INVENTION

The present invention provides a signal generation device which generates a packet containing information obtained by encoding a video signal using a video signal corresponding to a predetermined number of vertical periods as a unit and adds to the packet serial number information indicating the order of generation of the packet, in the order in which the packet is generated. The present invention also provides a radio video transmission device including this signal generation device.

The present invention provides a signal decoding device comprising a packet absence detection circuit for detecting serial number information added to a packet which is radio-received and determining absence of the packet; a decoding circuit for decoding the radio-received packet to obtain a video signal; and a memory for storing the video signal, wherein when absence of a packet is not detected by the packet absence detection circuit, the memory is caused to hold at least a portion of the video signal which is decoded in the decoding circuit, and when absence of a packet is detected by the packet absence detection circuit, the memory is caused to output the video signal stored therein. The present invention further provides a radio video reception device including this signal decoding device.

Preferably, the present invention may provide a signal generation/decoding device including the above signal generation device and the above signal decoding device. As well, preferably the present invention provides a radio video transmission/reception system including the above radio video transmission device and the above radio video reception device.

### BRIEF DESCRIPTION OF THE DRAWINGS

FIG. 1 is a block diagram showing a main portion of a radio video transmission/reception system according to an embodiment of the present invention;

FIG. 2 is a timing chart showing timing of each signal;

FIG. 3 is a view showing example data in which a serial number is added to a packet;

FIG. 4 is a timing chart for explaining phase adjustment between a reference signal and a decoding synchronization signal; and

FIG. 5 is a block diagram showing a structure of a conventional radio video transmission/reception system.

### DETAILED DESCRIPTION OF PREFERRED EMBODIMENT

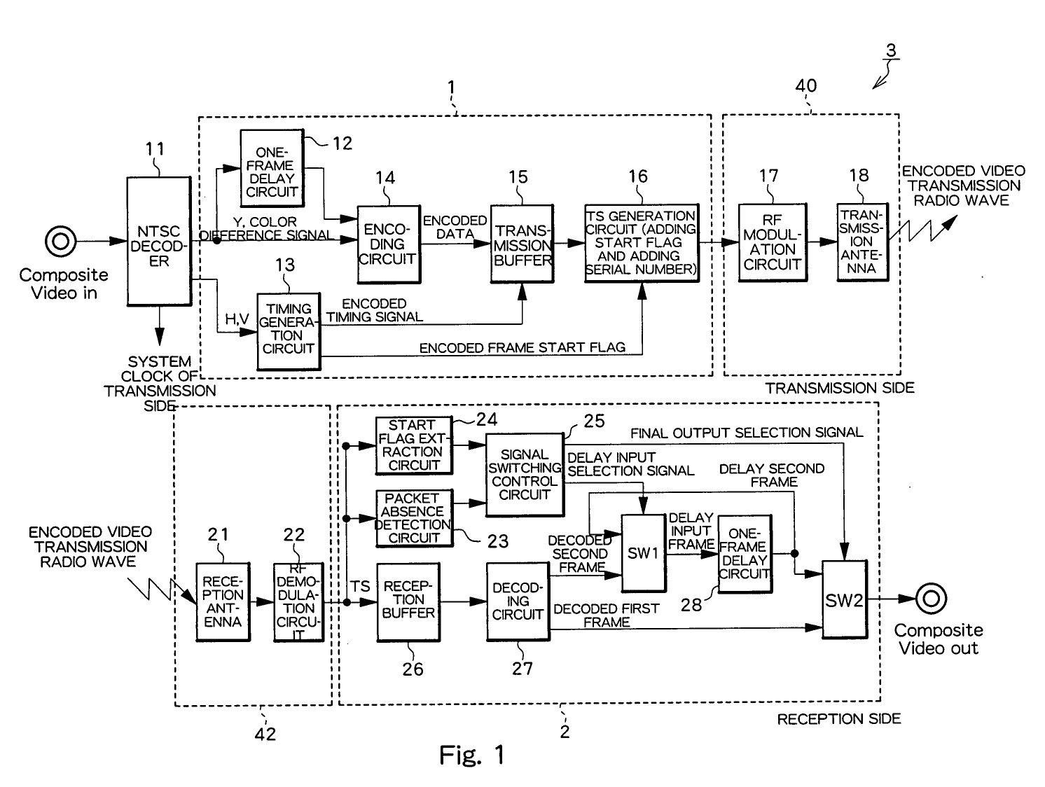

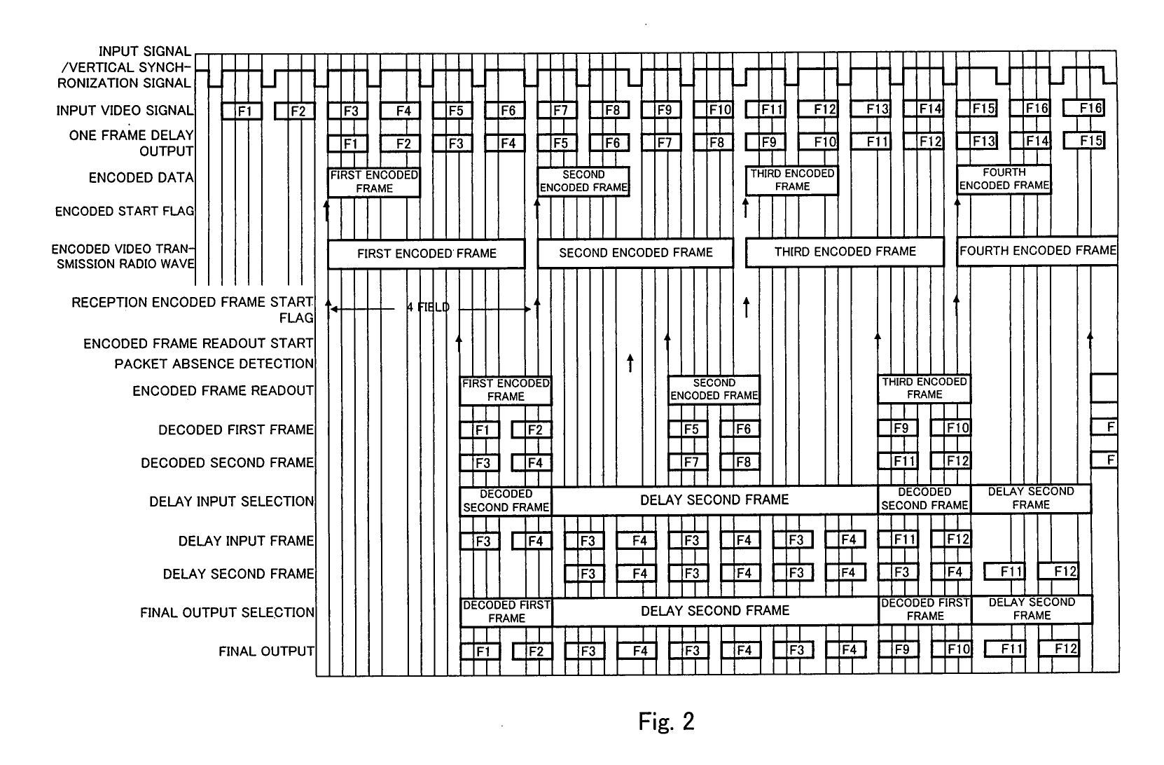

A preferred embodiment of the present invention will be described with reference to FIGS. 1 and 2. FIG. 1 is a block diagram showing a radio video transmission/reception system which is composed of a radio video transmission device and a radio video reception device, and FIG. 2 is a timing chart.

### Summary of the Embodiment

In this embodiment, a video signal of the NTSC (interlace) method in which a video signal corresponding to two fields forms one screen (one frame) will be described as an example. Further, a video signal which is encoded in units of a video signal corresponding to a predetermined number of vertical periods will be referred to as an encoded frame. In the present embodiment, the encoded video signal corresponding to four fields will be referred to as one encoded frame.

A radio video transmission device sets a transmission interval of the header data of the encoded frame to a predetermined number of vertical periods. Assuming that the length of one encoded frame is four fields, the transmission interval of the header data of the encoded frame would be four fields.

When transmitting the header data of the encoded frame, the radio video transmission device generates a transport stream in which a start flag indicative of the header portion of the encoded frame is added to the header portion of the encoded frame, and transmits the transport stream as a transmission packet. A radio video reception device generates a clock pulse at the encoded frame periods from a built-in horizontal period counter and a built-in vertical period counter. The radio video reception device forms a PLL (Phase Locked Loop) on the basis of a phase difference between the period of the clock pulse and the period of reception of the flag indicative of the header of an encoded frame, thereby adjusting the period of the clock pulse to achieve clock synchronization. Thus, the present embodiment eliminates the need for adding PCR, to thereby provide a radio video transmission/reception system having a simple circuit structure.

Further, the radio video transmission device sequentially adds to the transmission packet cyclical serial number information ranging from 0 to 15. Once the value of the serial number information reaches 15, the value of the serial number information for the next transmission packet is reset to 0. The radio video reception device extracts the serial number information from the received transmission packet. When the transmission packet is not received in the order of the serial numbers, the radio video reception device determines absence of the packet, and causes display of the video information included in the transmission packet which has been received previously.

[Radio Video Transmission Device]

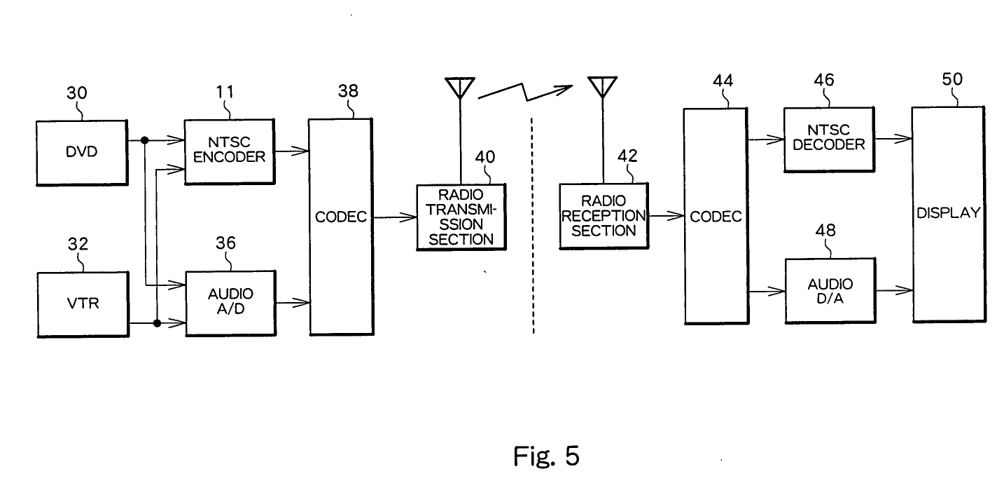

The radio video transmission device of the present embodiment may have a structure similar to that of the radio video transmission/reception device shown in FIG. 5, except that the codec 38 is replaced with a codec 1. The codec 1 corresponds to a signal generation device.

The NTSC encoder 11 receives a composite video signal and separates a Y (luminance) signal, a color difference signal, a horizontal synchronization signal (H), and a vertical synchronization signal (V) from the composite video signal. The Y signal, the color difference signal, the H signal, and the V signal are then supplied from the NTSC encoder 11 to the codec 1. An encoder circuit 14 receives the Y signal and the color difference signal one frame (two fields) before the present time, which have been subjected to a processing in one frame delay circuit 12, along with the Y signal and the color difference signal at the present time. In FIG. 2, the first encoded frame, which is encoded data, is composed of an encoded input video signal corresponding to four fields (F1, F2, F3, and F4: F refers to a field). As shown in FIG. 2, the encoder circuit 14 encodes the input video signal corresponding to four fields (F1, F2, F3, and F4) to generate the first encoded frame, and outputs the encoded frame to a transmission buffer 15 at intervals of every other frame period (every four vertical synchronization signals).

A frame synchronization signal which is a timing signal is generated by a timing generation circuit 13 and supplied to the transmission buffer 15. The timing generation circuit 13 outputs the frame synchronization signal at intervals of every two vertical synchronization periods (every two fields) on the basis of the H (horizontal synchronization signal) and the V (vertical synchronization signal) supplied from the NTSC decoder 11. Upon receiving the frame synchronization signal, the transmission buffer 15 outputs, at a predetermined bit rate, the encoded data stored in the buffer.

Further, the timing generation circuit 13 generates an encoded frame start flag and supplies the encoded frame start flag to a TS generation circuit 16. The encoded frame start flag is formed as a bit sequence which is not used as data (such as FFFh, for example) and is output at intervals of every two frame synchronization signals (every four fields).

The TS generating circuit 16 converts an output from the transmission buffer 15 into an MPEG2-based TS (transport stream), for example. At this time, the TS generating circuit 16 adds the encoded frame start flag to a top portion (a header portion) of the TS packet. In this case, because one encoded frame includes the encoded video signal corresponding to four fields, the encoded frame start flag is added to a video signal every four fields.

Also, the TS generating circuit 16 sequentially adds the cyclic serial number (continuity counter) information from 0 to 15 to a four-bit serial number region allocated to the top portion (the header portion) of the TS packet, in the order in which the TS packets are generated.

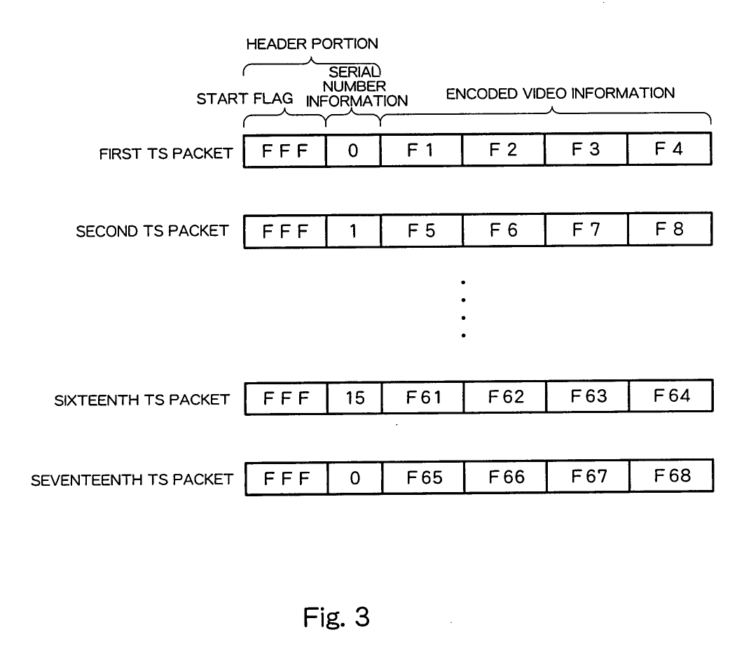

For example, as shown in FIG. 3, the serial number is added sequentially in such a manner that 0(0 h) is added to a TS packet corresponding to the first encoded frame, 1(1 h) is added to a TS packet corresponding to the second encoded frame, and so on. As such, the serial number 15 (Fh) is added to a TS packet corresponding to the sixteenth encoded frame, and then the serial number to be added to the next TS packet corresponding to the seventeenth encoded frame is reset to 0(0 h). In this manner, a set of the sequential numbers from 0 to 15 are added to every sixteen TS packets so as to enable discrimination of the time-based order in which these sixteen packets are generated.

An RF modulation circuit 17 applies high frequency digital modulation processing to the TS packets. The resultant RF modulation signal (a transmission wave) is transmitted by a transmission antenna section 18 into a space as an encoded video transmission radio wave.

[Radio Video Reception Device]

A radio video reception device of the present embodiment may have a structure similar to that of the radio video transmission/reception device shown in FIG. 5, except that the codec 44 is replaced with a codec 2. The codec 2 corresponds to a signal decoding device. Further, the codec 1 and the codec 2 may be formed into a single signal generating and decoding device.

The radio video reception device receives the encoded video transmission radio wave (RF modulation signal) transmitted from the radio video transmission device at a reception antenna 21. An RF demodulation circuit 22 applies digital demodulation processing to the received signal and outputs the processed signal as a demodulation signal TS to the codec 2.

The demodulation signal TS is temporarily stored in a reception buffer 26. A demodulation circuit 27 sequentially reads out and demodulates the demodulation signal TS stored in the reception buffer 26 in accordance with the timing required for demodulation. The timing is determined at a horizontal/vertical timing generating circuit (not shown).

A start flag extraction circuit 24 extracts the encoded frame start flag from the header portion of the demodulation signal TS, and supplies a reference signal to a phase comparison circuit (not shown) and a signal switching control circuit 25 at this timing of extraction of the encoded frame start flag. The horizontal/vertical timing generating circuit outputs to the phase comparison circuit and the demodulation circuit 27 a demodulation synchronization signal indicative of the reading start timing of the header of the encoded frame. The phase comparison circuit, which has received the reference signal, receives, as the other signal, this demodulation synchronization signal, and outputs to a voltage controlled oscillator (VCO: not shown) a phase comparison output indicative of a phase difference between the reference signal and the demodulation synchronization signal. The horizontal/vertical timing generating circuit adjusts and outputs the period of the demodulation synchronization signal in accordance with the oscillation frequency of the voltage controlled oscillator. With this structure, there can be formed a phase lock loop (PLL) for outputting a demodulation synchronization signal in synchronism with the timing for extraction of the encoded frame start flag indicative of the header of an encoded frame.

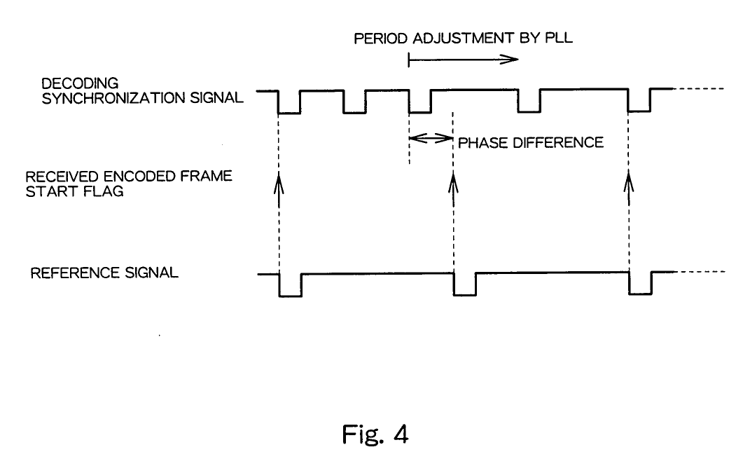

More specifically, as shown in FIG. 4, the period of the demodulation synchronization signal output from the horizontal/vertical timing generating circuit is corrected whenever necessary by the PLL formed by the horizontal/vertical timing generating circuit, the phase comparison circuit, and the voltage controlled oscillator, in accordance with the encoded frame start flag added to the TS which is being transmitted.

As described above, a shift of the four-field period at the reception side with respect to the four-field period at the transmission side is output as a phase comparison result, and this shift is corrected by the PLL. Consequently, synchronization of the clock at the transmission side with the clock at the reception side can be achieved without providing PCRs (program clock reference).

The demodulation circuit 27 demodulates the demodulation signal TS stored in the reception buffer 26 into a video signal in synchronization with the demodulation synchronization signal. Then, a portion of the decoded video signal corresponding to the first two fields of one encoded frame is output, as a decoded first frame, to a switch SW2, whereas the remaining portion corresponding to the second two fields of the one encoded frame is output, as a decoded second frame, to a switch SW1.

In the TS packet corresponding to the first encoded frame, for example, the decoded video signal corresponding to the fields F1 and F2 is input, as the decoded first frame, to the switch SW2, and the decoded video signal corresponding to the fields F3 and F4 is input, as the decoded second frame, to the switch SW1.

The switch SW1 selects one of the decoded second frame and a delay second frame stored in a one-frame delay circuit (memory) 28, according to a delay input selection signal, and outputs a selection result to the one-frame delay circuit 28. According to a final output selection signal, the switch SW2 selects and outputs one of the decoded first frame and the delay second frame supplied from the one-frame delay circuit 28.

A packet absence detection circuit 23 extracts the serial number (continuity counter) information from the header portion of the demodulated TS packet to thereby detect discontinuity of the numbers. When detecting discontinuity of the serial number information, the packet absence detection circuit 23 determines absence of TS packet and generates packet absence information and supplies the packet absence information to the signal switching control circuit 25.

Upon receiving the reference signal from the start flag extraction circuit 24, the signal switching control circuit 25 outputs to the switch SW2 a final output selection signal to cause the switch SW2 to first select the decoded first frame and, after the one-frame period, select the delay second frame (which is an output from the one-frame delay circuit 28). Specifically, with regard to the switch SW2, a state in which the decoded first frame is selected and a state in which the delay second frame is selected are switched for each frame. When receiving the packet absence information, however, the signal switching control circuit 25 does not cause the switch SW2 to select or output the decoded first frame according to the final output selection signal concerning the encoded frame (video signal corresponding to four fields) in which packet absence has been detected.

Further, upon receiving the reference signal, the signal switching control circuit 25 outputs to the switch SW1 a delay input selection signal to cause the switch SW1 to first select the decoded second frame and, after the one-frame period, select the delay second frame (which is an output from the one-frame delay circuit 28). Specifically, with regard to the switch SW1, a state in which the decoded second frame is selected and a state in which the delay second frame is selected are switched for each frame. Accordingly, when the delay second frame is output from the switch SW2, the delay second frame is returned to the one-frame delay circuit 28, whereas when the decoded first frame is output from the switch SW2, the one-frame delay circuit 28 newly stores the decoded second frame. When receiving the packet absence information, however, the signal switching control circuit 25 does not cause the switch SW1 to select or output the decoded second frame according to the delay input selection signal concerning the encoded frame (video signal corresponding to four fields) in which packet absence has been detected.

Referring to FIG. 2, if no packet absence occurs in the first encoded frame, due to the switching control of the switches SW1 and SW2, the decoded first frame supplied from the decoding circuit 27 is output through the SW2 and the decoded second frame supplied from the decoding circuit 27 is stored in the one-frame delay circuit 28 via the switch SW1 and is delayed by one frame period and then output, as the delay second frame, through the switch SW2. Accordingly, the selection states of the switch SW2 are sequentially switched as follows: a state in which the decoded first frame (F1, F2) is selected, a state in which the delay second frame (F3, F4) is selected, a state in which the decoded first frame (F5, F6) is selected, a state in which the delay second frame (F7, F8) is selected, and so on.

On the other hand, as shown in FIG. 2, when packet absence occurs for the second encoded frame, both the switches SW1 and SW2 are in a state in which the delay second frame is selected, and therefore the delay second frame (F3, F4) from the one-frame delay circuit 28 would be the final output. Further, this delay second frame continues to be returned to the one-frame delay circuit 28.

Then, if no packet absence occurs in the third encoded frame, the switches SW1 and SW2 are restored to their normal switching states. Accordingly, while the delay second frame (F3, F4) is output from the one-frame delay circuit 28 with the decoded first frame (F9, F10) being output, as the final output, from the switch SW2 at this time of recovery, the switch SW1 is now in a state where the decoded second frame (F11, F12) is selected, whereby the decoded second frame (F11, F12) is then stored in the one-frame delay circuit 28.

Although in the above example the unit of a predetermined number of vertical synchronization signals is four fields and compression (encoding) is performed on the basis of the difference between two frames, the present invention is not limited to this structure. For example, it is also possible that the unit of the predetermined number of vertical synchronization signals is set to sixteen fields and a B picture (a bidirectionally predictive encoded picture) may be generated as compression (encoding) according to a difference between frames. Here, as PCR is not provided, separate information in place of the description of the PTS (presentation time stamp) and DTS (decoding time stamp) can be provided in the PES (packetized elementary stream).

Further, although in the above example the one-frame delay circuit 28 is provided to hold the image data corresponding to one frame, it is sufficient to enable the one-frame delay circuit 28 to store image data corresponding to one or more fields. Also, although in the above example the serial number information from 0 to 15 is added at the transmission side, the serial numbers are not limited to these values.

Here, as the number of fields forming the unit of a predetermined number of vertical synchronization signals increases, a difference (time width) between the output video at the time of packet absence and the output video at the time of recovery increases. Further, the present invention is not limited to the above-described method in which a video signal is encoded in units of a video signal corresponding to a predetermined number of vertical periods.

As described above, the present invention provides an advantage that image disturbance caused by a transmission error can be suppressed with a simple circuit structure.

1. A radio video transmission device for encoding and packetizing video data and radio-transmitting a packet, the radio video transmission device being configured such that serial number information indicating the order of transmission of the packet is added to the packet.

2. A signal generation device for encoding and packetizing video data,
wherein
a packet including information obtained by encoding a video signal in units of a video signal corresponding to a predetermined number of vertical periods is generated, and
serial number information indicating the order of generation of the packet is added to the packet in the order in which the packet is generated.

3. A signal generation device according to claim 2, wherein
a flag indicative of a header portion of the packet is added to the header portion of the packet.

4. A radio video reception device for radio-receiving video data which is encoded and packetized, comprising:
means for detecting serial number information added to a packet to thereby determine absence of the packet;
a memory for storing the video data which have been decoded corresponding to at least one field;
means for sequentially updating received video data which are received normally and recording the video data in the memory; and
control means for outputting the video data stored in the memory in place of video data being received, when packet absence is determined.

5. A signal decoding device for decoding into a video signal a signal contained in a packet which is received through radio communication, comprising:
a packet absence detection circuit for detecting serial number information added to the packet which is radio-received to thereby determine absence of the packet;
a decoding circuit for decoding the radio-received packet into a video signal; and
a memory for storing the video signal,
wherein
when absence of the packet is not detected in the packet absence detection circuit, at least a portion of the video signal which is decoded in the decoding circuit is stored in the memory, and
when absence of the packet is detected in the packet absence detection circuit, the video signal stored in the memory is output.

6. A signal decoding device according to claim 5, comprising:
a flag extraction circuit for extracting a flag indicative of a header portion of a transmission signal added to the header portion of the radio-received transmission signal and outputing a reference signal at timing of extracting the flag,
wherein the decoding circuit decodes a signal contained in the packet at timing in accordance with the reference signal output from the flag extraction section.

7. A radio video transmission/reception system comprising:
a radio video transmission device for encoding and packetizing video data and radio-transmitting a packet, wherein the radio video transmission device is configured such that serial number information indicating the order of transmission of the packet is added to the packet; and
a radio video reception device for radio-receiving video data which is encoded and packetized, wherein the radio video reception device comprises:
means for detecting serial number information added to a packet to thereby determine absence of the packet,
a memory for storing the video data which have been decoded corresponding to at least one field,
means for sequentially updating received video data which are received normally and recording the video data in the memory, and
control means for outputting the video data stored in the memory in place of video data being received, when packet absence is determined.

8. A signal generation/decoding device comprising:
a signal generation device for encoding and packetizing video data,
wherein
a packet including information obtained by encoding a video signal in units of a video signal corresponding to a predetermined number of vertical periods is generated, and
serial number information indicating the order of generation of the packet is added to the packet in the order in which the packet is generated; and
a signal decoding device for decoding into a video signal a signal contained in a packet which is received through radio communication, wherein the signal decoding device comprises:
a packet absence detection circuit for detecting serial number information added to the packet which is radio-received to thereby determine absence of the packet,
a decoding circuit for decoding the radio-received packet into a video signal, and
a memory for storing the video signal,
wherein
when absence of the packet is not detected in the packet absence detection circuit, at least a portion of the video signal, which is decoded in the decoding circuit, is stored in the memory, and
when absence of the packet is detected in the packet absence detection circuit, the video signal stored in the memory is output.
